(19) United States
(12) Patent Application Publication
(10) Pub. No.: US 2015/0342147 A1
(43) Pub. Date: Dec. 3, 2015

(54) PET CARRIER

(71) Applicant: Chi-Chang Cheng, Changhua (TW)

(72) Inventor: Chi-Chang Cheng, Changhua (TW)

(73) Assignee: BU SHANG ENTERPRISE CO. LTD., Changhua (TW)

(21) Appl. No.: 14/295,274

(22) Filed: Jun. 3, 2014

(51) Int. Cl. A01K 27/00

(52) U.S. Cl. CPC A01K 27/001

(57) ABSTRACT

A pet carrier may include a main body and a protective layer. The protective layer is resilient and one side of the protective layer has a transition layer that can be attached to a surface of the protective layer by a glue. The protective layer is then sewed to the main body. One end of the main body has a first buckle unit, and a second buckle unit is disposed on an adjustable ring body passing through the other end of the main body. A connecting rod is disposed at a center portion of the adjustable ring body to secure the other end of the main body on the connecting rod.

### FIELD OF THE INVENTION

This invention relates to a pet carrier, and more particularly to a pet carrier with a protective layer that is resilient and soft to provide a comfortable environment for the pet.

### BACKGROUND OF THE INVENTION

Generally, a pet at home such as a cat or dog would wear a neck belt to identify itself and to connect to a longer string, so the owner can hold the string and the pet can move in a determined area. Conventional neck belt is made by nylon which is secured and inexpensive, so most pet owners tend to use the nylon neck belt. However, most of the nylon neck belts are not colorful and the surface thereof is rough, so the pet may feel uncomfortable if wearing it for a long period of time. Therefore, there remains a need for a new and improved pet carrier to overcome the problems stated above.

### SUMMARY OF THE INVENTION

Conventional neck belt is made by nylon which is secured and inexpensive, so most pet owners tend to use the nylon neck belt. However, most of the nylon neck belts are not colorful and the surface thereof is rough, so the pet may feel uncomfortable if wearing it for a long period of time.

To solve the problem stated above, the present invention provides a pet carrier may include a main body and a protective layer. The protective layer is resilient and one side of the protective layer has a transition layer that can be attached to a surface of the protective layer by a glue. The protective layer is then sewed to the main body. One end of the main body has a first buckle unit, and a second buckle unit is disposed on an adjustable ring body passing through the other end of the main body. A connecting rod is disposed at a center portion of the adjustable ring body to secure the other end of the main body on the connecting rod.

Comparing with conventional arts, the present invention is advantageous because (i) the main body has the protective layer on an outer surface thereof, so the main body has a certain degree of flexibility due to the protective layer to increase the comfortable level for the pets. Furthermore, since the protective is resilient and soft, the friction between the pet and the surface of the protective layer has been minimized; and (ii) the transition layer can be decorated with different color, so the user can better identify the carrier.

### BRIEF DESCRIPTION OF THE DRAWINGS

FIG. 1 illustrates a three-dimensional view of the present invention.

FIG. 2 illustrates an exploded view of the present invention.

FIG. 3 illustrates an enlarged exploded view and schematic view of the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

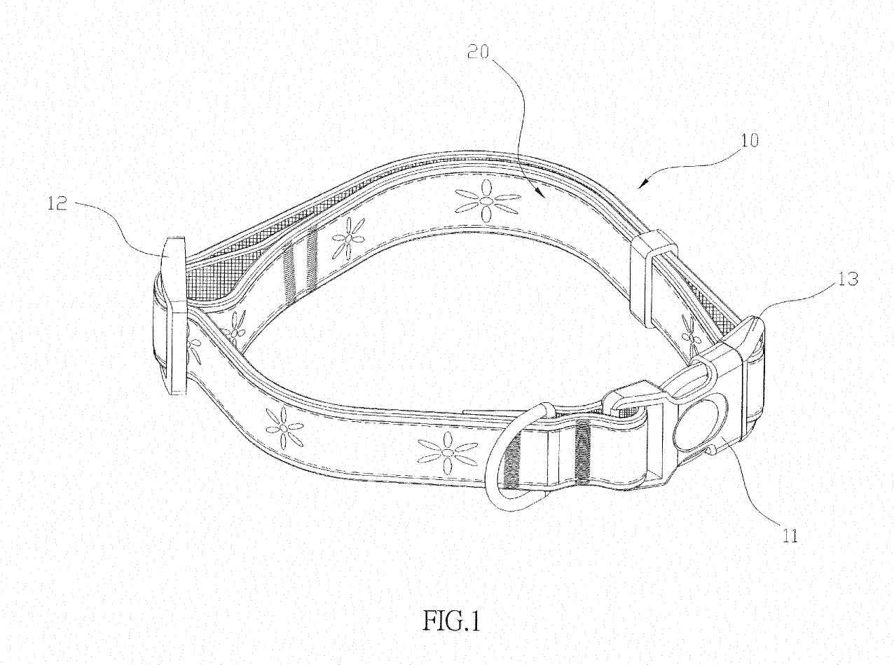

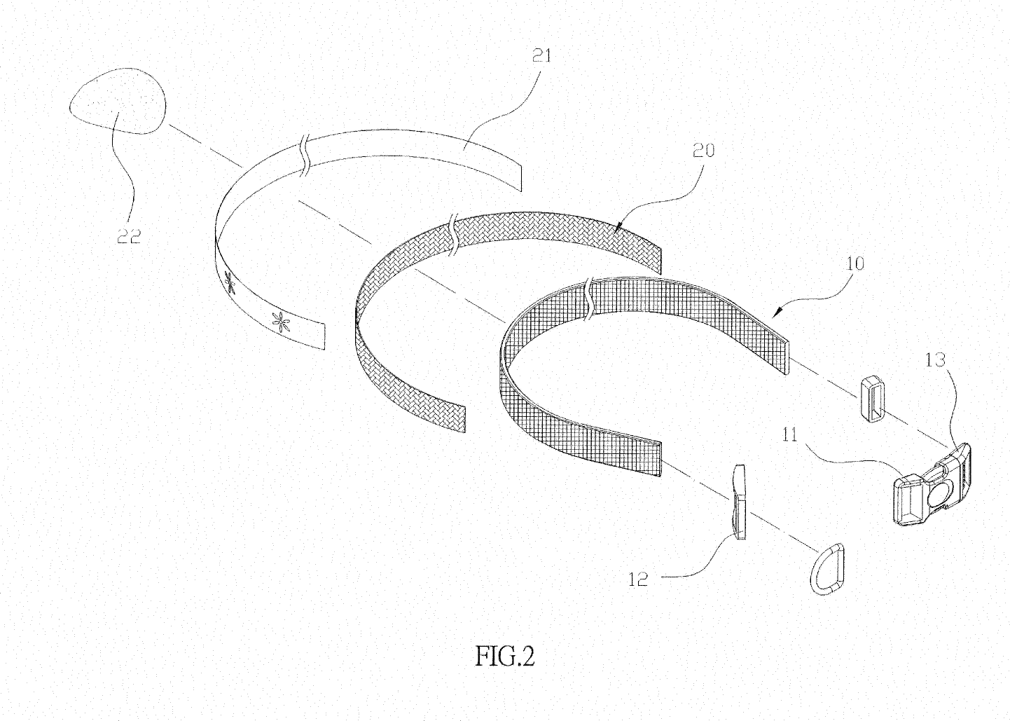

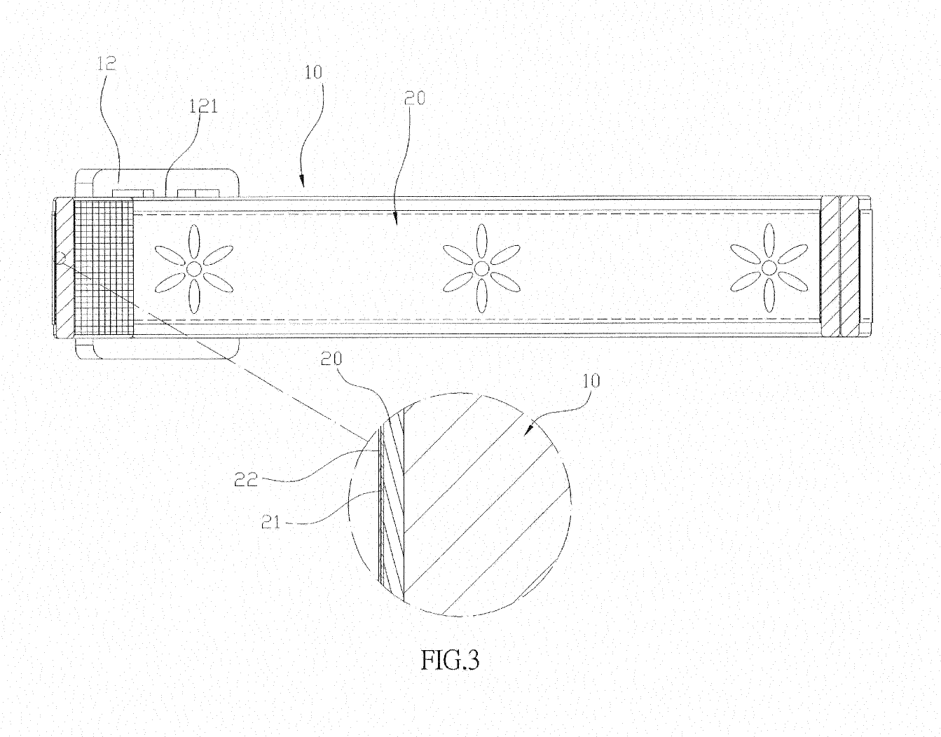

Referring FIGS. 1 to 3, a pet carrier may include a main body 10 and a protective layer 20. The protective layer 20 is resilient and one side of the protective layer 20 has a transition layer 21 that can be attached to a surface of the protective layer by a glue 22. The protective layer 20 is then sewed to the main body 10. One end of the main body 10 has a first buckle unit 11, and a second buckle unit 13 is disposed on an adjustable ring body 12 passing through the other end of the main body 10. A connecting rod 121 is disposed at a center portion of the adjustable ring body 12 to secure the other end of the main body 10 on the connecting rod 121.

When in use, referring to FIGS. 1 to 3, the main body 10 is actually a neck belt put on the neck portion of the pet. The main body 10 can be used for identification or connecting with other pet items. Since the main body 10 has the protective layer 20 on an outer surface thereof, the main body 10 has a certain degree of flexibility because of the protective layer 20 to increase the comfortable level for the pets. Furthermore, since the protective is resilient and soft, the friction between the pet and the surface of the protective layer 20 has been minimized.

According to the embodiments discussed above, the present invention is advantageous because (i) the main body 10 has the protective layer 20 on an outer surface thereof, so the main body 10 has a certain degree of flexibility due to the protective layer 20 to increase the comfortable level for the pets. Furthermore, since the protective is resilient and soft, the friction between the pet and the surface of the protective layer 20 has been minimized; and (ii) the transition layer 21 can be decorated with different color, so the user can better identify the carrier.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A pet carrier comprising:
a main body; and
a resilient protective layer having a transition layer attached to the resilient layer with a glue, and the protective layer is sewed to an outer surface of the main body.

2. The pet carrier of claim 2, wherein one end of the main body has a first buckle unit, and a second buckle unit is disposed on an adjustable ring body passing through the other end of the main body, and a connecting rod is disposed at a center portion of the adjustable ring body to secure the other end of the main body on the connecting rod.
